(19) United States
(12) Patent Application Publication
(10) Pub. No.: US 2007/0061482 A1
(43) Pub. Date: Mar. 15, 2007

(54) Information processing apparatus, communication control method, and communication control program

(75) Inventor: Naoshi Higuchi, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/492,825

(22) Filed: Jul. 26, 2006

(30) Foreign Application Priority Data
Aug. 3, 2005 (JP) 2005-225461

(51) Int. Cl. G06F 15/173

(52) U.S. Cl. 709/238

(57) ABSTRACT

In an information processing apparatus, a computer includes plural communication interface means corresponding to networks different from each other, a routing means for selecting communication interface means corresponding to a communication request issued by a task from a routing table in which the relation between destinations of communication and communication interface means to be used in the communication is prescribed, a task table update means for recording a combination of a task and communication interface means used in a first communication carried out by the task to a task table and deleting a record as to the task from the task table when the task is finished, and a communication interface restriction means for permitting the communication when the selection carried out by the routing means corresponds to the task table and shutting off the communication when the selection does not correspond to the task table.

### BACKGROUND OF THE INVENTION

1. Field of the Invention

The present invention relates to an information processing apparatus, a communication control method, and a communication control program, and more particularly, to a technology used to prevent leakage of information in an information processing apparatus having plural communication interfaces.

2. Description of the Related Art

Recently, as information networks represented by the Internet, company networks, and the like become wide spread, the information networks are required to have reliability as a social infrastructure. In particular, a communication control technology capable of preventing leakage of information is increasingly required from a view point of security such as protection of personal information and the like.

In the conventional information networks, equipment connected to plural information networks are limited to relay equipment such as exchangers and routers. Since these equipment are placed under control of an information network manager, problems of security are unlike to arise.

However, recently, computer equipment of end users are connected to plural information networks. As an example, a personal computer of an end user is connected to an company network through LAN as well as connected to the Internet through a public wireless network such as a mobile phone network and further connected to external LAN through Virtual Private Network (VPN) in the Internet.

Examples of conventional communication systems are disclosed in Japanese Patent Application Laid-Open Publication (JP-A) Nos. 2002-247033, 4-235652, and 8-44642. In the system disclosed in JP-A 2002-247033, an information security policy management/audit support apparatus is connected to computers to be managed and audited such as a server, a router, a firewall, and the like through an information network. In the system, the security of an information network is managed by indicating a group of information network policies that can be applied to equipment to be managed which is selected by an information network manager and selecting an information processing apparatus security policy by the information network manager.

In the system disclosed in JP-A 4-235652, when a computer A communicates with a computer C through a computer B on an information network, the addresses of the computers A and B on the information network are sent together with a communication connection request. Thus, the computer C can be aware of that the communication from the computer A is carried out through the computer B. The computer C determines whether or not the communication is to be connected based on an access permission list.

The system disclosed in JP-A 8-44642 accepts (passes) or rejects (drops) a communication packet by checking the communication packet by a packet filter module placed at a strategic point in an information network.

Incidentally, although equipment, which can be connected to the plural external networks as described above, simultaneously uses plural communication interfaces to execute a task, data is liable to leak to the outside by using the plural networks. Accordingly, it is required to employ a communication control technology to prevent leakage of information.

The invention disclosed in JP-A 2002-247033 is effective when a single manager manages a single information network. However, it may be not effective in a communication mode in which equipment used by an end user is connected to plural information networks. This is because since a different information network is generally managed by a different manager, it is difficult to harmonize respective information security policies to prevent leakage of information.

The invention disclosed in JP-A 4-235652 may be not effective when the electronic computers B and C belong to different information networks. This is because there is a possibility that an information security management may not be carried out similarly to both the computers that belong to the different information networks, and, in this case, it is difficult to apply the invention to both the computers.

In the invention of JP-A 8-44642, when an application task operates on equipment on which a packet module filter is placed, communication is ended by the application task. Accordingly, even if the application task is connected to plural networks, it is difficult for the packet filter module to determine the relation between the plural networks to which the application task is connected and danger of information leakage.

In addition to the above-mentioned, it is exemplified as a problem of security that arises when plural communication interfaces are simultaneously used to carry out a task that it is difficult to predict a communication interface to be used by the task.

This is because a communication interface used to a task is dynamically set when a communication actually starts in order to enhance the versatility of task. Further, when the VPN technology described above is used, since a communication interface is logically handled, communication interfaces can be relatively easily added and deleted. Accordingly, communication interfaces may be frequently switched while a task is carried out, from which it is difficult to predict the communication interfaces.

An object of the present invention, which was made in view of the above problems, is to provide a method capable of secure communication security when a task is carried out by an information processing apparatus that can be connected to plural networks.

### SUMMARY OF THE INVENTION

An information processing apparatus according to the present invention includes a computer for carrying out a task and a plurality of communication interface devices for connecting the computer to a plurality of networks, wherein the computer includes plural communication interface means that correspond to networks different from each other and transmit and receive data to and from a corresponding network through the communication interface devices; a routing means for selecting communication interface means corresponding to a communication request issued by the task from a routing table in which the relation between destinations of communication and communication interface means to be used in the communication is prescribed, a task table update means for recording a combination of a task and communication interface means used in a first communication carried out by the task to a task table and deleting a record as to the task from the task table when the task is finished, and a communication interface restriction means for permitting the communication when the selection carried out by the routing means corresponds to the task table and shutting off the communication when the selection does not correspond to the task table.

A basic idea of the present invention resides in that only a communication interface that is used first by a task is made effective as a communication interface used to carry out the task. Accordingly, even if it is intended to carry out communication though a communication interface different from that used in the first communication in response to a second and subsequent communication requests issued by the task, the communication is shut off.

According to the present invention, it can be prohibited that one task uses plural communication interfaces together. As a result, since the communication interface used by the task is fixed, problems in communication security such as leakage of secret data and the like can be made to be unlike to occur. Further, since setting as to restriction of use of communication interfaces is effective until a task is finished, the restriction of use can be effective applied to a protocol to which a communication interface is dynamically allocated to each of the communication request issued by the same task.

### BRIEF DESCRIPTION OF THE DRAWINGS

FIG. 1 is a block diagram showing a hardware arrangement of an embodiment according to the present invention;

FIG. 2 is a block diagram showing a function arrangement of an information processing apparatus of the embodiment;

FIG. 3 is a sequence view showing an operation sequence of the embodiment;

FIG. 4 is a flowchart explaining the operation sequence of the embodiment;

FIG. 5 is a view explaining a specific example of the embodiment;

FIG. 6 is a block diagram showing a hardware arrangement of an information processing apparatus of the specific example;

FIG. 7 is a block diagram showing a function arrangement of the information processing apparatus of the specific example;

FIG. 8 is a sequence view (part 1) showing the operation sequence of the specific example; and

FIG. 9 is a sequence view (part 2) showing the operation sequence of the specific example.

### DESCRIPTION OF THE PREFERRED EMBODIMENTS

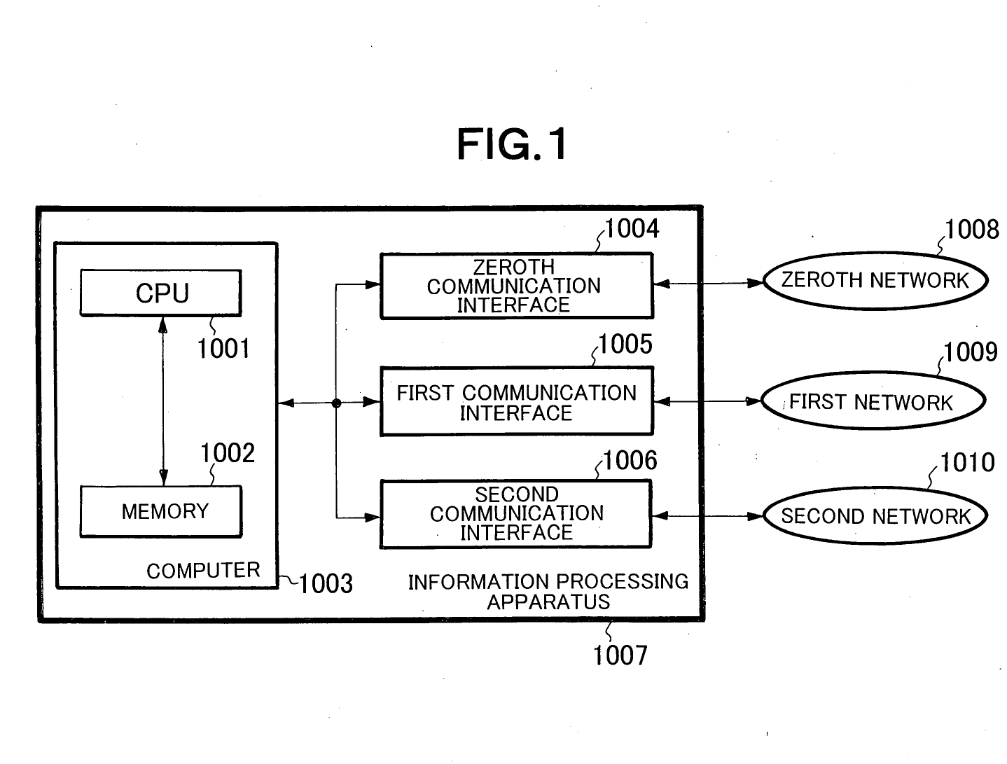

Embodiments for embodying present invention will be described in detail with reference to the drawings. Referring to FIG. 1, a first embodiment of the present invention is an information processing apparatus 1007 including a computer 1003, which has a CPU 1001 for carrying out arithmetic operation and a memory 1002 acting as a storage unit, and plural communication interfaces (1004 to 1006) as peripheral devices of the computer 1003. The illustrated example is provided with three communication interfaces, that is, a zeroth communication interface 1004, a first communication interface 1005, and a second communication interface 1006.

The above communication interfaces (1004 to 1006) are interface hardware for connecting the computer 1003 to networks (1008 to 1010) in a predetermined communication mode and specifically composed of a wired LAN communication interface card such as Ethernet® and a wireless LAN communication interface card, and the like.

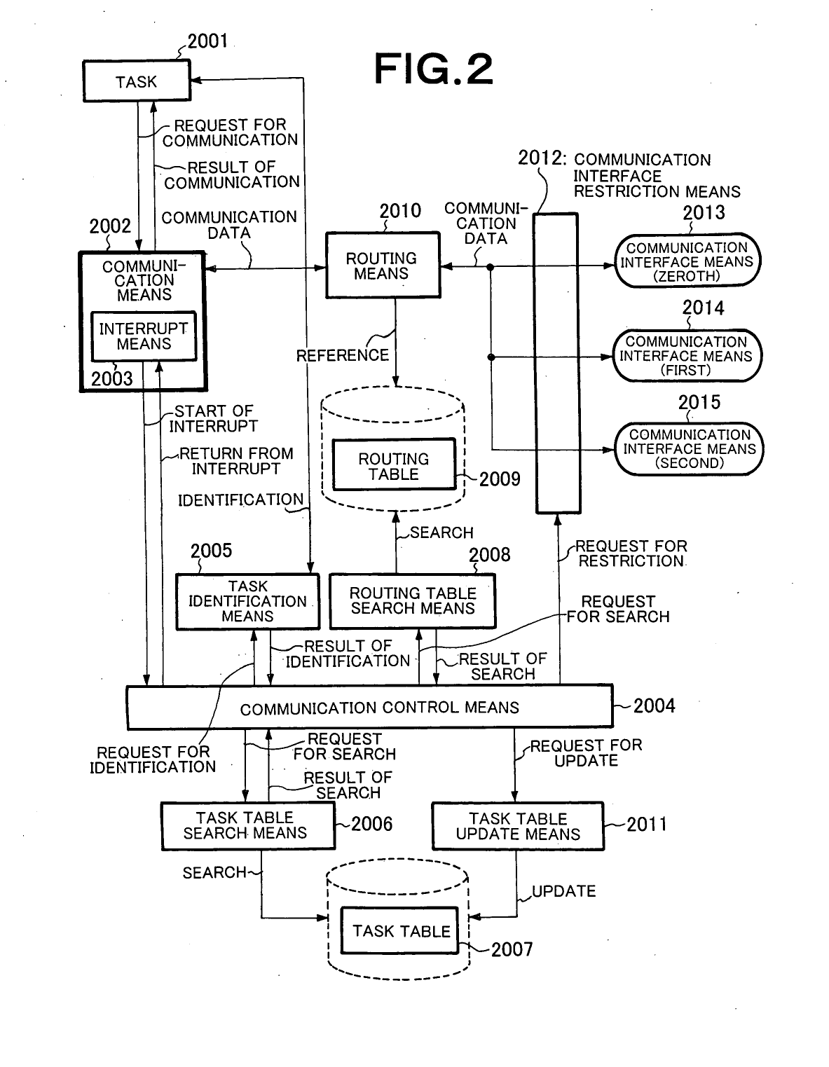

FIG. 2 shows a function block that is realized by carrying out software such as an operating system, middleware, and the like by the information processing apparatus 1007. A task 2001 is a unit program corresponding to any of processings. The following means are provided to restrict the communications required by the task 2001 while the task 2001 is processed.

A communication means 2002 is a means used when the task 2001 carries out communication and composed of software operating on the computer 1003. When the task 2001 uses the communication means 2002, it typically calls a function of API, system call, and the like prepared to the operating system according to a type of a communication request. The type of the communication request includes start of communication (transmission for connection, waiting for connection, acceptance of connection), transmission, reception, and finish of communication. The communication means 2002 transmits and receives communication data in response to a request for communication from a task.

An interrupt means 2003 is a means for causing a different processing to interrupt before the task 2001 is processed by the communication means 2002 and composed of software, for example, a hook command operating on the computer 1003. The interrupt means 2003 of the embodiment carries out interruption by jumping the execution point of the CPU 1001 to the address of a communication control means 2004 allocated on the memory 1002 of the computer 1003. The address of the communication control means 2004 to which the execution point is jumped is stored as a function table on the memory 1002 and registered at the start of the operating system and the like.

The communication control means 2004 is a means for controlling communication of a task and composed of software operating on the computer 1003. The communication control means 2004 controls the communication of the task making use of a task identification means 2005, a task table search means 2006, a routing table search means 2008, a task table update means 2011, and a communication interface restriction means 2012. The operation of the communication control means 2004 will be described in detail later.

The task identification means 2005 is a means for obtaining a task identifier and composed of software operating on the computer 1003. A process ID managed by the operating system is typically used as the task identifier. The operating system manages a process ID corresponding to a latest communication request as a process ID of a task that operates at present. The task identification means 2005 obtains the process ID of the task that operates at present.

What is managed by the operating system by applying a task identifier to it is operation typical to an operating system for supporting a multitask. In a single task operating system, the task identification means 2005 obtains the same task identifier at all times.

A task table 2007 records the relation between a task and a network used in an initial communication carried out by the task and specifically records a combination of a task identifier and the identifier of a communication interface. In a communication carried out by a multitask, the task table 2007 records plural task identifiers corresponding to the communication. It is regarded that the tasks recorded to the task table are already allocated with a communication interface. Although the task table 2007 is typically stored on the memory 1002 of the computer 1003, it may be stored on a detachable external storage medium such as a flash memory card.

The task table search means 2006 is a means for searching the task table 2007 described above using the task identifier as a key and composed of software operating on the computer 1003. When the task identifier acting as the key is registered to the task table 2007, a response that allocation is carried out is returned, whereas it is not registered, a response that no allocation is carried out is returned.

The routing table search means 2008 is a means for searching a routing table 2009 to be described later using a destination of communication as a key and composed of software operating on the computer 1003. Although a destination address of communication is different depending on a communication protocol, it is the IP address of a destination in, for example, IP communication. Since a specific identifier of communication interface is different depending on an operating system and on a communication protocol handled by a communication interface, it will be explained using an actual example.

In wired LAN such as Ethernet®, “eth0”, “eth1, and the like are used as the identifier of communication interface that handles IP communication on, for example, Linux that is UNIX® operating system, and “eth0” and “eth1” are used in wireless LAN. Further, in Windows® that is an operating system made by Microsoft, “local area connection 1”, “wireless network connection 2, and the like corresponds to the identifier of communication interface.

The routing table 2009 is a list of combination of destinations of communications and communication interfaces used in the communications. Although the routing table 2009 is typically stored on the memory 1002, it may be stored on an external storage medium such as a flash memory.

The task table update means 2011 is a means for registering and deleting a task identifier to and from the task table 2007 and composed of software operating on the computer 1003.

The communication interface restriction means 2012 is a means for restricting the communication of the respective communication interfaces and selects whether the communication data of each communication interface is to be passed or dropped and indicates the result selection to the communication interface. To designate a communication interface, the identifier of it is used.

In the embodiment, the communication interface restriction means 2012 is arranged as a communication filter. The communication filter determines whether the communication data is to be passed or dropped based on the information of a communication destination, a communication source, and the like and may be referred to as a so-called firewall. Note that the above function is provided with many existing communication filters and is a technology known to persons skilled in the art. The communication filter is composed of software as a communication protocol stack operating on the computer 1003.

Note that since plural communication interface means can be arranged by software with respect to a single piece of communication interface hardware by a technology for providing a virtual communication interface represented by VPN technology, the number of pieces of hardware of the communication interface may not be in agreement with that of software of it.

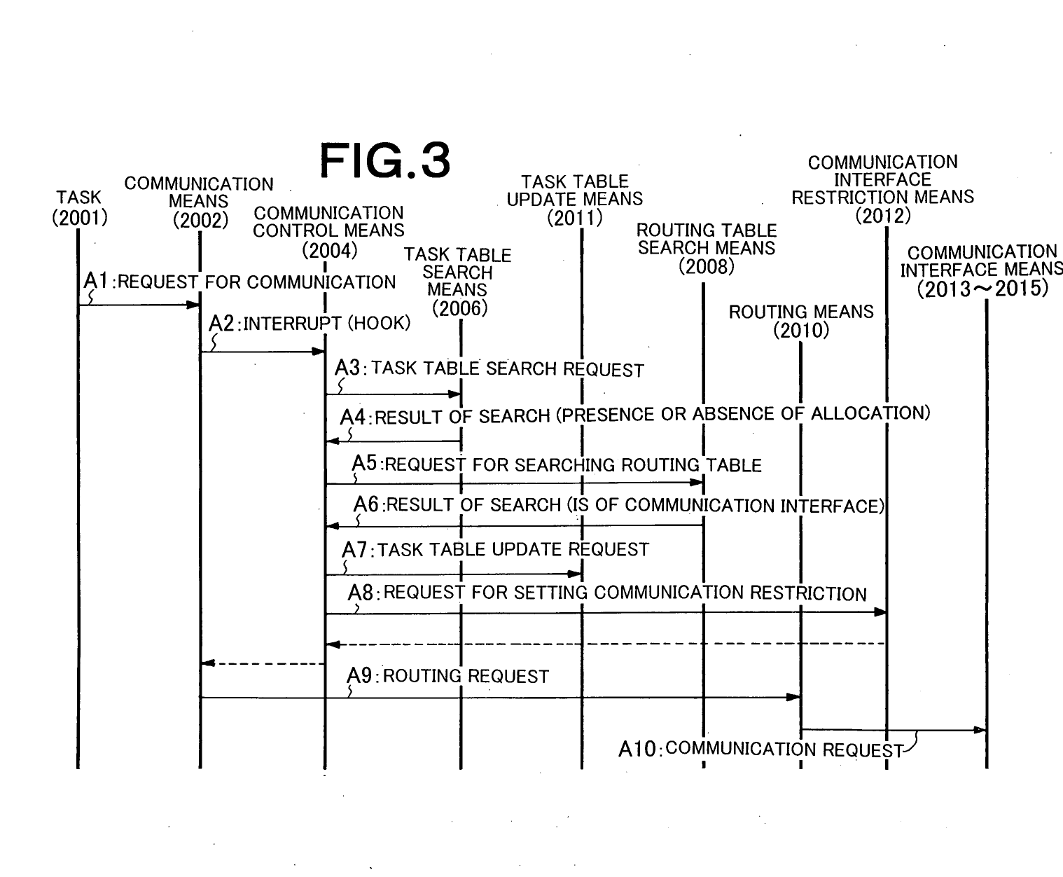

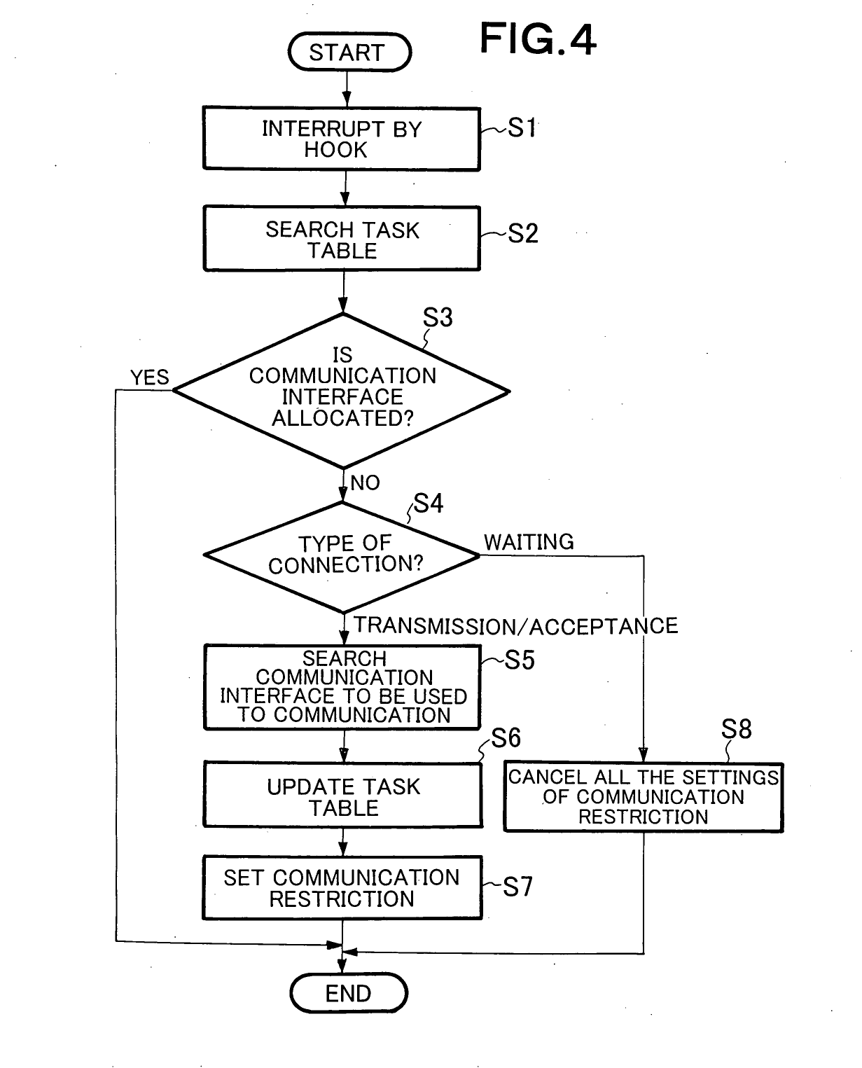

Overall operation of the embodiment will be explained with reference to the sequence of FIG. 3 and the flowchart of FIG. 4. Note that, in the following sequence, the interrupt means 2003 of the components shown in FIG. 2 will be explained as a hook means 2003A.

First, when the task 2001 must communicate with external equipment, the task 2001 issues a communication request to the communication means 2002 (FIG. 3: step A1). In the communication request, two types of data, that is, a type of request and a communication parameter are notified to the communication control means 2004. The content of the communication parameter is different depending on the type of the communication request. When the communication request is, for example, transmission for connection when a communication starts, the communication parameter is a destination, and, when it is waiting for connection at the time the communication starts, the communication parameter is the maximum length of the queue of connection in a pending status. Further, when the type of the communication request is acceptance of connection or finish of communication, no data exists as the communication parameter. Further, when the communication request is transmission, the communication parameter is transmission data, whereas when it is reception, the storage destination of received data is the communication parameter.

When a communication means 3002 receives the communication request from the task 2001, the hook means 2003A causes the following processings to interrupt before the communication means 3002 requests routing to a routing means 3007 (FIG. 4: step S1).

The hook means 2003A notifies of the communication control means 2004 of the communication request and the communication parameter, which are obtained from the task 2001, and the task identifier (FIG. 3: step A2). At the time, the hook means 2003A obtains the task identifier to be notified to the communication control means 2004 from the task identification means 2005.

Further, the data from the task 2001 is basically used as the communication parameter to be notified to the communication control means 2004. However, when the communication request is the acceptance of connection in IP communication at the time the communication starts, the IP address of a transmission source is added. This is because it is a typical operation to automatically allocate the IP address to a communication party by the communication means 3002 at the time at which the task 2001 issues the acceptance of connection.

The communication control means 2004 notifies the task table search means 2006 of the task identifier obtained from the hook means 2003A and requests to search the task table 2007 (FIG. 3: step A3). The task table search means 2006 searches the task table 2007 based on the notified task identifier (FIG. 4: step S2) and determines whether or not a communication interface is allocated to the task identifier.

At the time, when the communication of this time is a communication at second and subsequent times carried out by the task 2001, since the combination of the task identifier and the communication interface is already recorded to the task table 2007, it is determined that the communication interface is already allocated (step S3: YES). The task table search means 2006 notifies the communication control means 2004 of the identifier of the communication interface allocated to the task identifier (FIG. 3: step A4).

The communication control means 2004 finishes the interrupt at the time and indicates the communication means 2002 to carry out communication in the same sequence as the conventional one without changing the restriction of the communication interface from the present one. That is, the communication means 2002 carries out the communication (step A10) in such a manner that the communication means 2002 notifies a routing means 2010 of the identifier of the communication interface, the communication data, and the like (step A9), and the routing means 2010 delivers data to interface means (2013 to 2015) corresponding to the notified identifier.

In contrast, when the communication of this time is an initial communication carried out by the task 2001 as in the start of communication, the communication interface is not yet allocated to the communication identifier (FIG. 4: step S3: NO). In this case, the following processings are carried out depending on the type of the communication request.

When the communication request is the transmission for connection or the acceptance of connection at the time the communication request is issued to start communication (step S4: transmission/acceptance), the communication control means 2004 notifies the the routing table search means 2008 of the communication destination (transmission for connection) or the transmission source address (acceptance of connection) and requests it to search the routing table 2009 (FIG. 3: step A5, FIG. 4: step S5). The routing table search means 2008 searches the identifier of a communication interface to be used to communication and notifies the communication control means 2004 of the identifier as the result of search (step A6).

The communication control means 2004 notifies the task table update means 2011 of the identifier of the communication interface, which is obtained from the routing table search means 2008, and the task identifier and requests it to update the task table 2007. The task table update means 2011 updates the task table 2007 by adding a combination of the task identifier and the identifier of the communication interface obtained from the communication control means 2004 to the task table 2007 (FIG. 3: step A7, FIG. 4: step S6).

Further, the communication control means 2004 notifies the communication interface restriction means 2012 of the identifier of the communication interface used to communication and requests it to restrict communication (step A8). The communication interface restriction means 2012 makes setting to permit communication only to the communication interfaces (1004 to 1006) of the identifier obtained from the communication control means 2004 (FIG. 4: step S7).

When the setting for restricting communication is updated, the communication control means 2004 completes the interrupt processing and carries out communication by the same sequence as the conventional one. With this operation, only the communication through the communication interface designated by the task 2001 of this time is permitted and the communication through the other communication interfaces is shut off.

Further, when the communication request of the task 2001 is the waiting for connection (step S4: waiting), the communication control means 2004 carries out neither the processing as to the search of the routing table 2009 (FIG. 3: steps A5, A6) nor the processing as to the update of the task table 2007 (step A7) and requests the communication interface restriction means 2012 to cancel all the restrictions set to the communication interfaces at the time (FIG. 3: step A8, FIG. 4: step S8).

When the task 2001 is finished after the control described above is carried out, a task monitor function (not shown) provided with the computer 1003 notifies the task table update means 2011 of the task identifier, and the task table update means 2011 deletes the information as to the task identifier from the task table 2007.

As described above, in the embodiment, the control is carried out to make only the communication interface used by the task 2001 first effective as the communication interface used to carry out the task 2001. Accordingly, even if the task 2001 attempts to use a different communication interface in second and subsequent communications, the communications are shut off. With this arrangement, it is prohibited for the single task 2001 to simultaneously use plural communication interfaces. As a result, security in communication can be secured.

Further, in the embodiment, since the setting as to the restriction of use of the communication interfaces is effective until the task 2001 is finished, the restriction of use also effectively acts to a protocol to which a communication interface is dynamically allocated to each communication request of the task 2001.

Further, in the embodiment, since the above control sequence is carried out by the interruption to the same communication sequence as the conventional one, it is not necessary to modify the task 2001 itself. This is particularly advantageous in that when a protocol to which a communication interface is dynamically allocated is used, it is not necessary to modify the task 2001 to fix a communication interface for the task 2001.

Next, a second embodiment of the present invention will be explained with reference to FIGS. 1 and 2. In the embodiment, a computer 1003 is provided with a communication interface restriction means 2012 as driver software of a zeroth communication interface 1004, a first communication interface 1005, and a second communication interface 1006. In the second embodiment, the communication interface restriction means 2012 controls whether communication is permitted or not by tuning on and off power supplied to a part of circuits of the respective communication interfaces (1004 to 1006).

### SPECIFIC EXAMPLE

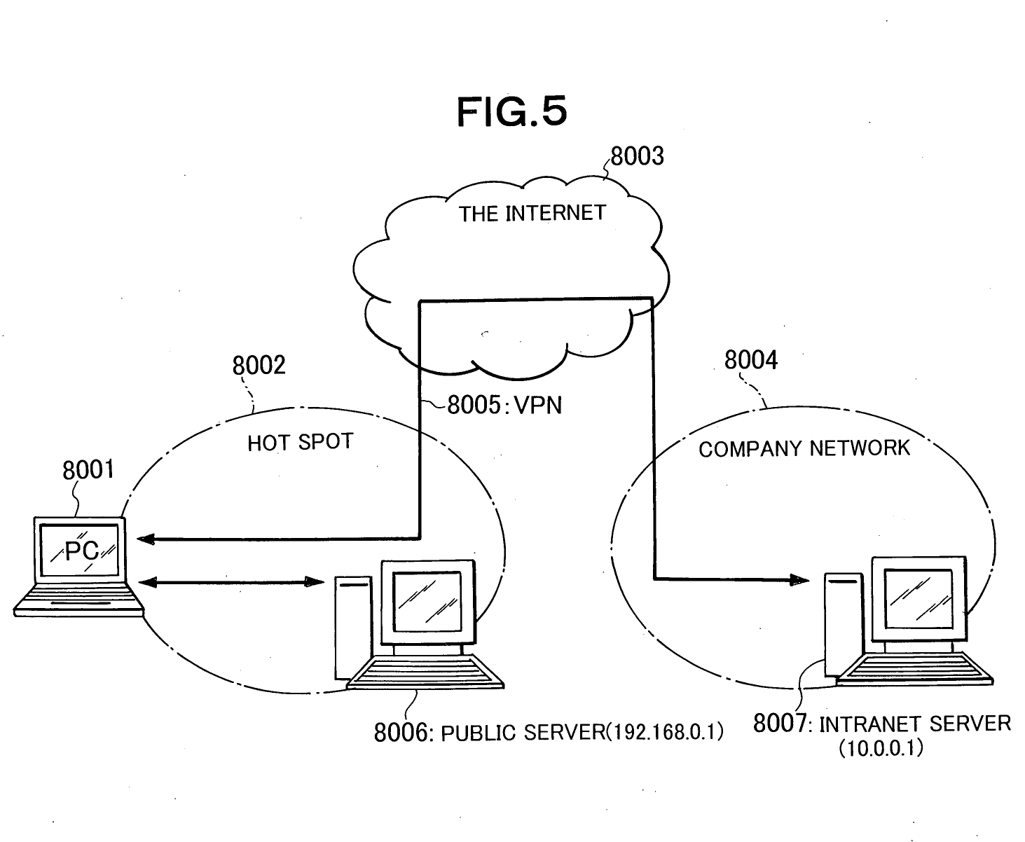

Operation of the embodiment will be explained in detail using a specific example. As shown in FIG. 5, in the specific example, a PC 8001 is disposed at a hot spot 8002 as an area in which a wireless LAN environment is provided, and the PC 8001 is connected to a intranet server 8007 in a company network 8004 through the Internet 8003 by a public server 8006 in the hot spot 8002. VPN 8005 is used for communication between the PC 8001 and the intranet server 8007 in consideration of leakage of information in the hot spot 8002 and in the Internet 8003. A safe communication path can be secured by the arrangement.

In the specific example, the PC 8001 receives data belonging to the confidential matters of the company from the intranet server 8007 having reliability as to security by carrying out an application program described below and transmits the received data to the intranet server 8007 after it is edited. With this operation, the confidential data on the intranet server 8007 is updated by the PC 8001 in a distant place.

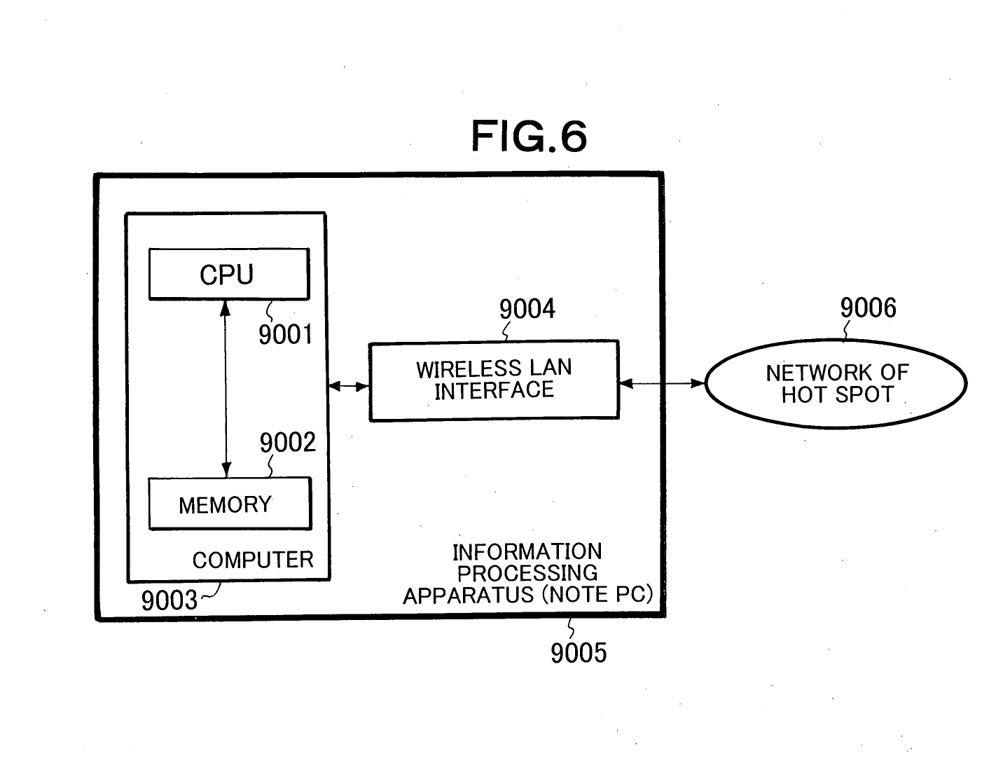

FIG. 6 shows a main hardware arrangement of an information processing apparatus 9005 corresponding to the PC 8001 of FIG. 5. The information processing apparatus 9005 includes a computer 9003 having a CPU 9001 and a memory 9002 and a wireless LAN interface 9004 as peripheral equipment of the computer 9003. The computer 9003 can carry out a data edit application program stored in the memory 9002 by the CPU 9001. Further, the computer 9003 is connected to the network 9006 of the hot spot by the wireless LAN interface 9004.

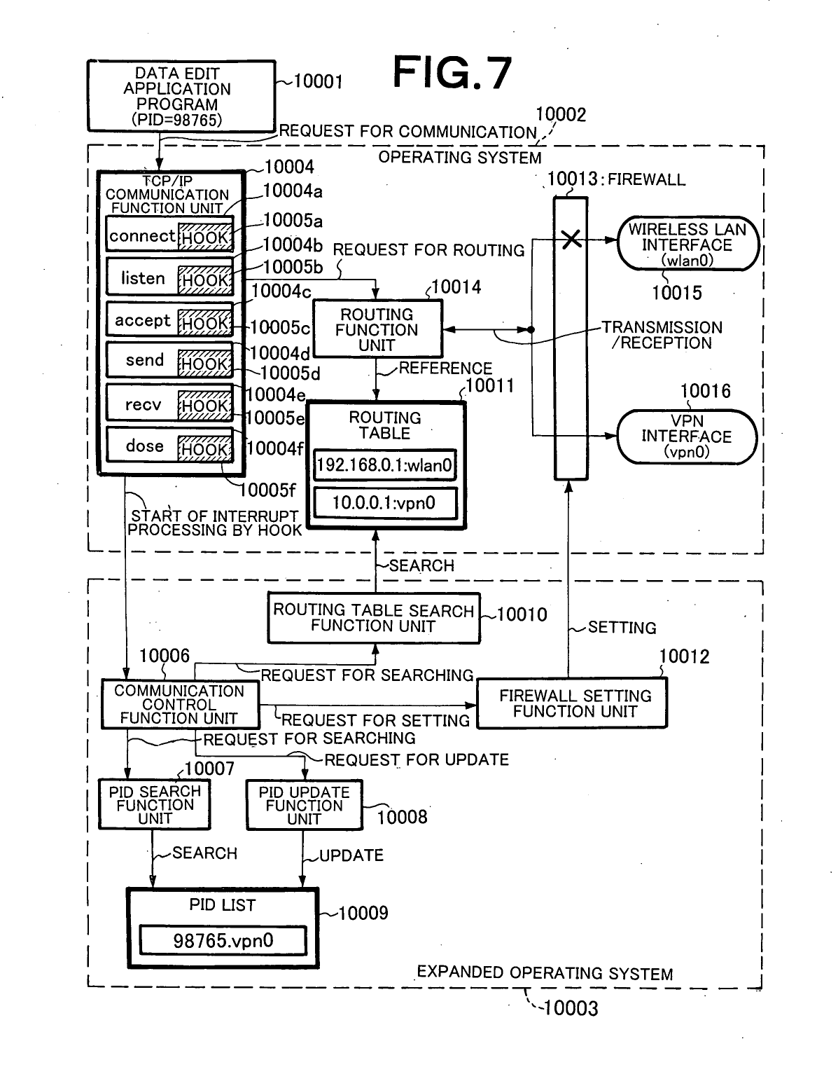

FIG. 7 shows a function arrangement of the information processing apparatus 9005. The illustrated arrangement corresponds to a function realized by the CPU 9001 which carries out operating systems (1002, 10003) and the data edit application program (10001) which are stored in the memory 9002. The data edit application program 10001 is a program for editing the confidential data received from the intranet server 8007 (FIG. 5).

It is assumed that the operating system of the specific example is a UNIX system. The operating system of the UNIX system ordinarily uses PID (Process ID) as information for identifying respective programs. In the sequence described below, it is assumed that a number “98765” is given as the PID of the data edit application program 10001.

The operating system 10002 achieves the same function as a conventional operating system and is composed of a technology known to the persons skilled in the art. Although the operating system 10002 of the specific example is the UNIX operating system as described above, the present invention can be also embodied by other existing operating system in place of it. The operating system of the computer 9003 is composed of the operating system 10002 and the expanded operating system 10003 as an expanded portion for embodying the present invention.

A TCP/IP communication function unit 10004 has a function for carrying out TCP/IP communication. Further, the TCP/IP communication function unit 10004 has a system call (10004a to 10004f) acting as interfaces when the application program 10001 carries out communication by TCP/IP.

As shown in FIG. 7, the system call includes a connect system call 10004a for carrying out transmission for connection when communication starts, a listen system call 1004b for waiting connection when the communication starts, an accept system call 10004c for accepting connection when the communication starts, a send system call 10004d for transmitting data, a recv system call 10004e for receiving the data, a close system call 10004f for finishing the communication, and the like. Although these system calls are ordinary system calls in the UNIX operating system, an interface called Winsock API is prepared in the Windows® system of Microsoft.

The system calls 10004a to 10004f are provided with hooks 10005a to 10005f, respectively. When a corresponding system call is called, the hooks 10005a to 10005f operate so that a processing to be described later is interrupted by a communication control function unit 10006 before a routing processing is requested to a routing function unit 10014.

Further, when the corresponding system call is called, the hooks 10005a to 10005f notify the communication control function unit 10006 of the expanded operating system 10003 of communication parameters of the system call such as the type of the system, a destination IP address and a port number given to the system when it is called, and the identifier (PID) of the application program 10001.

Note that although the operating system 10002 is provided with the hooks 10005a to 10005f of the specific example as standard, when they are not provided as standard, an interrupt processing function is added to the operating system to embody the present invention. As a method of addition, a processing for calling the communication control function unit 10006 is added to the leading end of the system call by interruption. For example, when the operating system is described in C Language, a processing for calling a function, in which the processing of the communication control function unit 10006 is described, is added to the leading end of the system call described in C language.

The expanded operating system 10003 includes the communication control function unit 10006 corresponding to the communication control means 2004 of FIG. 2, a PID list 10009 corresponding to the task table 2007, a PID list search function unit 10007 corresponding to the task table search means 2006, a PID list update function unit 10008 corresponding to the task table update means 2011, a routing table search function unit 10010 corresponding to the routing table search means 2008, and a firewall setting function unit 10012 corresponding to the communication interface restriction means 2012.

The communication control function unit 10006 carries out the following functions. That is, the communication control function unit 10006 notifies the PID list search function unit 10007 of the PID obtained from any of the hooks (10005a to 10005f) and asks it whether or not a communication interface is allocated to the PID. The communication control function unit 10006 indicates the PID list update function unit 10008 to allocate or cancel a communication interface to the PID. The communication control function unit 10006 notifies the routing table search function unit 10010 of the communication parameter obtained from any of the hooks (10005a to 10005f) and asks it the identifier of a communication interface corresponding to the communication parameter.

Further, the communication control function unit 10006 determines the setting of the communication of a firewall 10013 based on the type of the communication request obtained from any of the hooks (10005a to 10005f), on the result of search obtained from the PID list search function unit 10007, and on the result of search obtained from the routing table search function unit 10010. Then, the communication control function unit 10006 notifies the firewall setting function unit 10012 of the determined content and the identifier of the communication interface and requests it to set communication to the firewall 10013.

The PID list 10009 shows the relation between PID and the communication interface allocated to the PID and is recorded in a memory 9002.

The PID list search function unit 10007 searches the PID list 10009 using the PID notified from the communication control function unit 10006 as a key, and when the PID exists in the PID list 10009, the PID list search function unit 10007 responds that an object application program 10001 is allocated to any of the communication interfaces to the communication control function unit 10006. Further, when the PID used as the key does not exist in the PID list 10009, the PID list search function unit 10007 responds that no communication interface is allocated to the object application program 10001 to the communication control function unit 10006.

The PID list update function unit 10008 updates the PID list 10009 according to the indication notified from the communication control function unit 10006 as to the allocation of a communication interface to PID. When the PID list update function unit 10008 is indicated to make new allocation, it adds a combination of an object PID and a communication interface, whereas when the PID list update function unit 10008 is indicated to cancel allocation, it deletes the combination of objects from the PID list 10009.

A routing table 10011 is a list of paths in an IP network. The routing table 10011 includes information for determining a communication interface appropriate to a given communication destination. Further, the routing table 10011 is updated as necessary by a not shown update unit in response to dynamic addition or deletion of communication interfaces.

The routing table search function unit 10010 searches the routing table 10011 using the communication interface notified from the communication control function unit 10006 as a key and responds the identifier of the communication interface used in the communication of this time to the communication control function unit 10006. In a search processing carried out to the routing table 10011 in the UNIX operating system, the identifier of the communication interface can be taken out from routing table 10011 in a format of text by using, for example, a route command.

The routing function unit 10014 selects a predetermined path according to the destination of communication (IP address) referring to the routing table 10011.

The firewall setting function unit 10012 makes setting to the communication filter of the firewall 10013 based on the indication as to the allocation of a communication interface notified from the communication control function unit 10006 and on the identifier of the communication interface.

A wireless LAN interface 10015 is a logical communication interface corresponding to the physical wireless LAN interface 9004 and connects it to the network 9006 of the hot spot. It is assumed in the specific example that a communication interface identifier called “wlan0” is given to the wireless LAN interface 10015.

Although a VPN interface 10016 physically corresponds to the wireless LAN interface 9004, it is logically a communication interface corresponding to a VPN 8005 that is a communication path virtually secured by a cipher technology. The communication carried out by the VPN interface 10016 is connected to the hot spot 8002 by the physical wireless LAN interface 9004 and further connected to the company network 8004 through the Internet 8003. It is assumed in the specific example that a communication interface identifier called “vpn0” is given to the VPN interface 10016.

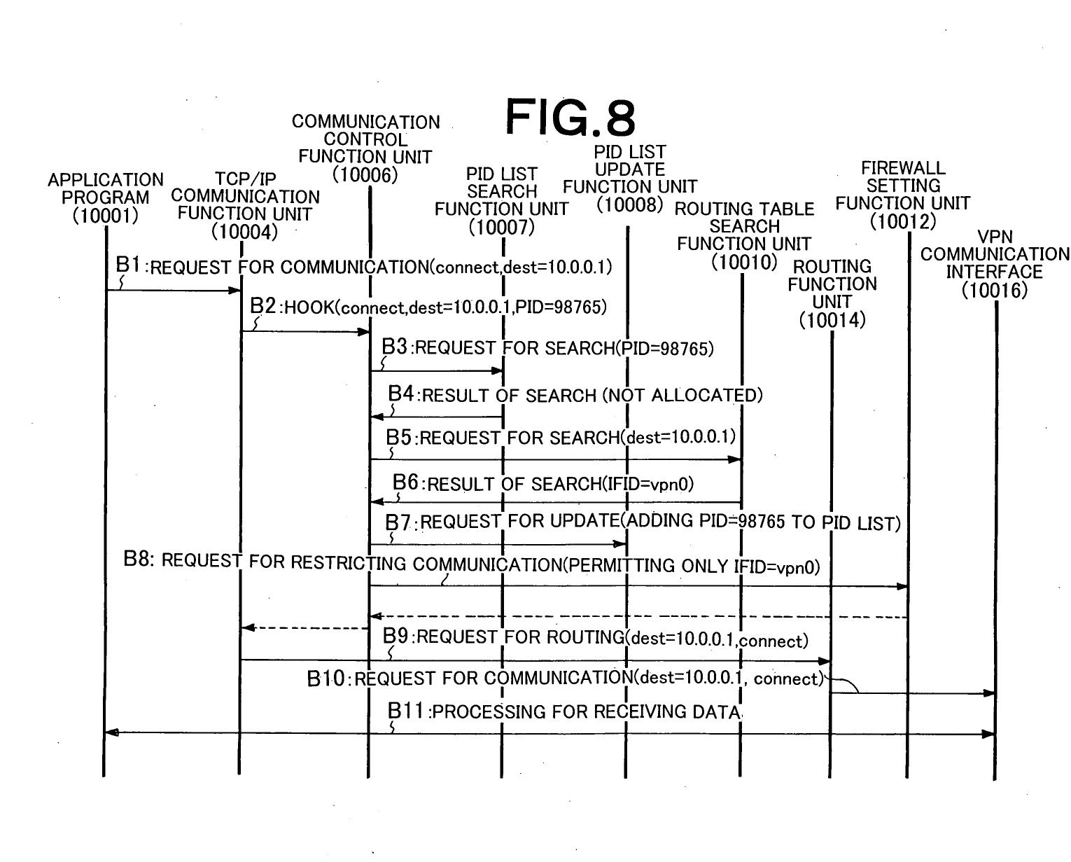

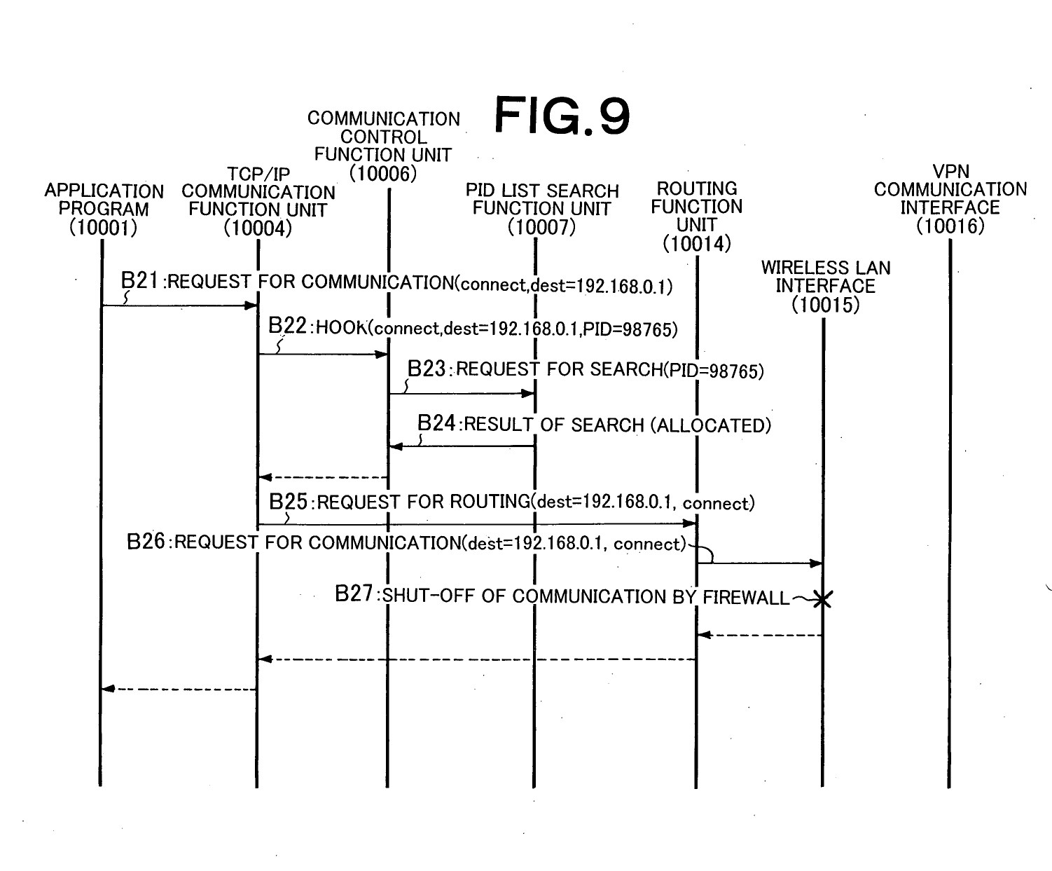

An operation sequence of the specific example will be explained with reference to the sequences shown in FIGS. 8 and 9. First, when the data edit application program 10001 is started by the PC 8001, the application program 10001 requests the TCP/IP communication function unit 10004 to connect to the intranet server 8007 to obtain data to be edited from the intranet server 8007 of the company network 8004 (step B1). At the time, the TCP/IP communication function unit 10004 is notified of a connect request and a destination IP address “10.0.0.1”.

On receiving the communication request from the data edit application program 10001, the TCP/IP communication function unit 10004 notifies the communication control function unit 10006 of the connect request, the destination IP address “10.0.0.1”, and the PID “98765” of the application program 10001 through the hook 10005a before the connect system call 10004a starts (step B2).

The communication control function unit 10006 notifies the PID list search function unit 10007 of the PID “98765” notified from the TCP/IP communication function unit 10004 and requests it to search the PID list 10009 (step B3). At the time, since communication is not yet carried out by the application program 10001, the PID “98765” is not allocated to any of the communication interfaces, and thus no record as to the PID “98765” exists in the PID list 10009. The PID list search function unit 10007 returns a response of “not yet allocated” to the communication control function unit 10006 (step B4).

On receiving the response of “not yet allocated” the communication control function unit 10006 notifies the routing table search function unit 10010 of a destination IP address “dest=10.0.0.1” and requests it to search the routing table 10011 (step B5). The routing table search function unit 10010 searches the routing table 10011 using “dest=10.0.0.1” as a key. As shown in FIG. 7, it is assumed that it is set here to select the VPN interface 10016 to communicate with the intranet server 8007 making use of VPN 8005 whose security is secured (“10.0.0.1:vpn0”). The routing table search function unit 10010 responds a communication interface identifier “IFID=vpn” to the communication control function unit 10006 as a result of search (step B6).

On receiving the result of search from the routing table search function unit 10010, the communication control function unit 10006 notifies the PID list update function unit 10008 of the communication interface identifier “IFID=vpn0” and the “PID=98765” of the application program 10001 and requests it to update the PID list 10009 (step B7). The PID list update function unit 10008 adds an entry of “PID=98765” to the PID list 10009 in response to the request.

Next, the communication control function unit 10006 permits the firewall setting function unit 10012 to make communication through the VPN interface 10016 corresponding to “IFID=vpn0” as well as requests the firewall setting function unit 10012 to make setting for shutting off communication through other communication interfaces to the firewall 10013 (step B8).

On the completion of the above processing, the communication control function unit 10006 indicates the TCP/IP communication function unit 10004 to start communication by a manner similar to a conventional one. On receiving the indication, the TCP/IP communication function unit 10004 completes the interrupt processing carried out by the hook 10005a, starts the connect system call 10004a and notifies the routing function unit 10014 of the connect request and the destination “dest=10.0.0.1” notified from the application program 10001 (step B9). The routing function unit 10014 recognizes to make use of the VPN interface 10016 corresponding to “IFID=vpn0” to the communication whose destination is “dest=10.0.0.1” referring to the routing table 10011 and issues a communication request to the VPN interface 10016 (step B10).

When the VPN interface 10016 transmits a connection request to the intranet server 8007 having the destination “dest=10.0.0.1” in the company network 8004 and establishes a communication, the application program 10001 obtains data belonging to company secret from the intranet server 8007 (step B11).

Next, referred to sequence in FIG. 9, how the setting for restricting communication described with reference to FIG. 8 operates when secret data edited by the application program 10001 is transmitted to the intranet server 8007 will be explained.

The application program 10001 issues a communication request to the TCP/IP communication function unit 10004 to transmit the data edited by it to the intranet server 8007 (step B21). At the time, it is assumed that the public server 8006 (IP address: 192.168.0.1) of the hot spot 8002 whose security is not guaranteed is designated as a destination of communication due to a mistake of operation of the PC 8001, a bug of the application program 10001, and the like regardless that the intranet server 8007 (IP address: 10.0.0.1) is actually to be designated as the destination of communication.

On receiving the connect request from the application program 10001, the TCP/IP communication function unit 10004 notifies the communication control function unit 10006 of the connect request, the PID “98765” of the application program 10001, and the destination IP address “192.168.0.1” through the hook 10005a before the connect system call 10004a starts (step B22).

The communication control function unit 10006 requests the PID list search function unit 10007 to search the PID list 10009 using the PID as a key (step B23). At the time, since the application program 10001 already carried out communication to the outside, that is, since communication was carried out in the past by the sequence of FIG. 8, the PID of the application program 10001 is recorded on the PID list 10009. Accordingly, the PID list search function unit 10007 returns a response of “allocated” to the communication control function unit 10006 (step B24).

On receiving the response of “allocated”, the communication control function unit 10006 recognizes that the setting of communication of the firewall 10013 is not changed and indicates the TCP/IP communication function unit 10004 to start communication by a manner similar to a conventional one. On receiving the indication, the TCP/IP communication function unit 10004 completes the interrupt processing carried out by the hook 10005a and starts the connect system call 10004a. Then, the TCP/IP communication function unit 10004 notifies the routing function unit 10014 of the connect request from the application program 10001 and the destination IP address “dest=192.168.0.1” (step B9).

The routing function unit 10014 recognizes that the communication interface identifier related to the destination IP address “dest=192.168.0.1” is “IFID=wlad0” referring to the routing table 10011. The routing function unit 10014 issues a connect request to the wireless LAN interface 10015 corresponding to “IFID=wlad0” (step B26).

Since the firewall setting function unit 10012 already made the setting for shutting off communication making use of the wireless LAN interface 10015 to the firewall 10013, the communication request of this time is shut off (step B27). Thereafter, the failure of the communication request is notified from the routing function unit 10014 to the application program 10001 through the TCP/IP communication function unit 10004.

When the application program 10001 transmits secret data to the intranet server 8007, it can be prevented by the operation explained above that a communication means other than VPN 8005 is used. With this operation, leakage of secret data in the hot spot 8002 can be avoided.

The present invention can be preferably applied to prevent leakage of data handled by a communication apparatus. A useful countermeasure for security can be established by applying the present invention to personal computers having a communication function, so-called smart phones as phone terminals having a high function, and the like.

Although the exemplary embodiments of the present invention have been described in detail, it should be understood that various changes, substitutions and alternatives can be made therein without departing from the sprit and scope of the invention as defined by the appended claims. Further, it is the inventor's intent to retrain all equivalents of the claimed invention even if the claims are amended during prosecution.

What is claimed is:

1. An information processing apparatus comprising a computer for carrying out a task and a plurality of communication interface devices for connecting the computer to a plurality of networks, wherein, the computer comprises:
a plurality of communication interface means that correspond to networks different from each other and transmit and receive data to and from a corresponding network through the communication interface devices;
routing means for selecting communication interface means corresponding to a communication request issued by the task from a routing table in which the relation between destinations of communication and communication interface means to be used in the communication is prescribed;
task table update means for recording a combination of a task and communication interface means used in a first communication carried out by the task to a task table and deleting a record as to the task from the task table when the task is finished; and
communication interface restriction means for permitting the communication when the selection carried out by the routing means corresponds to the task table and shutting off the communication when the selection does not correspond to the task table.

2. An information processing apparatus according to claim 1, wherein when a record as to the task that has issued the communication request does not exist in the task table, the computer records the combination of the communication interface means corresponding to the communication request and the task in the routing table to the task table by the task table update means.

3. An information processing apparatus according to claim 1, wherein the computer comprises means for connecting the computer to a virtual communication path as the plurality of communication interface means.

4. An information processing apparatus according to claim 1, wherein the computer permits or rejects the communication carried out by the respective communication interface means by controlling a power supply to the communication interface devices.

5. A communication control program for causing a computer, which carries out a task as well as is connected to a plurality of communication interface devices so as to be connected to a plurality of networks, to function as a plurality of communication interface means that correspond to networks different from each other as well as transmit and receive data to and from a corresponding network through the communication interface devices;
routing means for selecting communication interface means corresponding to a communication request issued by the task from a routing table in which the relation between destinations of communications and communication interface means to be used to the communication is prescribed;
task table update means for recording a combination of a task and communication interface means used in a first communication carried out by the task and deleting a record as to the task from the task table when the task is finished; and
communication interface restriction means for permitting the communication when the selection carried out by the routing means corresponds to the task table and shutting off the communication when the selection does not correspond to the task table.

6. A communication control program according to claim 5, wherein when the record as to the task that has issued the communication request does not exist in the task table, the communication control program causes the computer to record the combination of the communication interface means corresponding to the communication request and the task in the routing table to the task table by the task table update means.

7. A communication control program according to claim 5, wherein the plurality of communication interface means comprises means for connecting the computer to a virtual communication path.

8. A communication control program according to claim 5, wherein the communication control program causes the computer to permit or reject the communication carried out by the respective communication interface means by controlling a power supply to the communication interface device.

9. A communication control method of a computer, which carries out a task as well as is connected to a plurality of communication interface devices so as to be connected to a plurality of networks and comprises a plurality of communication interface means that correspond to networks different from each other and transmit and receive data to and from a corresponding network through the communication interface devices, the method comprising steps of:
recording a combination of a task and communication interface means used in a first communication carried out by the task and deleting a record as to the task from the task table when the task is finished;
selecting communication interface means corresponding to a communication request issued by the task from a routing table in which the relation between destinations of communications and communication interface means to be used in the communications is prescribed; and
permitting the communication when the selection carried out by the routing means corresponds to the task table and shutting off the communication when the selection does not correspond to the task table.

10. A communication control method according to claim 9, wherein when the record as to the task that has issued the communication request does not exist in the task table, the computer records the combination of the communication interface means corresponding to the communication request and the task in the routing table to the task table.

11. A communication control method according to claim 9, wherein means for connecting the computer to a virtual communication path is included as the plurality of communication interface means to be provided with the computer.

12. A communication control method according to claim 9, wherein the computer permits or shuts off communication carried out by the respective communication interface means by controlling a power supply to the communication interface device.
